(19) United States
(12) Patent Application Publication
(10) Pub. No.: US 2016/0064779 A1
(43) Pub. Date: Mar. 3, 2016

(54) LITHIUM ION BATTERY SYSTEM

(71) Applicant: HITACHI, LTD., Tokyo (JP)

(72) Inventors: Hirofumi TAKAHASHI, Tokyo (JP); Atsuhiko ONUMA, Tokyo (JP)

(73) Assignee: HITACHI, LTD., Tokyo (JP)

(21) Appl. No.: 14/813,319

(22) Filed: Jul. 30, 2015

(30) Foreign Application Priority Data
Aug. 29, 2014 (JP) 2014-175582

(51) Int. Cl. H01M 10/42; H01M 10/058; H01M 10/0525

(52) U.S. Cl. CPC H01M 10/4242; H01M 10/0525; H01M 10/058; H01M 2220/20

(57) ABSTRACT

It is provided a computer system, comprising a plurality of computers configured to execute processing in response to requests received from a plurality of external systems. The plurality of computers share an acceptance weight statistic value calculated by each of the plurality of computers with another computer within the same network segment. The processor of each of the plurality of computers is configured to: receive a broadcast transmitted from one of the plurality of external systems to the same network segment; determine whether to respond to the received broadcast by referring to the shared acceptance weight statistic value; and send a response to the one of the plurality of external systems that has transmitted the broadcast in order to allow the one of the plurality of external systems to transmit a processing request in a case where it is determined to respond to the received broadcast.

### BACKGROUND OF THE INVENTION

1. Field of the Invention

The present invention relates to a lithium-ion battery system including a nonaqueous lithium-ion secondary battery. More particularly, the present invention relates to a lithium-ion battery system with a high-energy density which is suitable for electric automobiles and electric energy storage apparatus.

2. Description of the Related Art

Lithium-ion batteries suffer a disadvantage of decreasing in battery capacity after repeated charging and discharging and with a lapse of time, which leads to a decrease in the amount of energy to be charged and discharged. One of the mechanisms responsible for the decrease in battery capacity is side reactions that occur on the surface of the anode active material based on a carbonaceous material. Such side reactions form a film on the anode surface, thereby causing lithium ions (resulting from charging) to be immobilized in the anode. This results in the decrease in the amount of lithium ions involved in charging and discharging, which brings about the decrease in battery capacity.

A countermeasure for capacity decrease in lithium-ion batteries was disclosed in International Publication Number: WO 2012/124211 (hereinafter, referred to as Patent Document 1). It consists of judging whether or not the capacity decrease is due to a decrease in lithium ions, calculating the amount of decrease, and replenishing the battery with lithium ions to compensate for decrease, thereby recovering the battery capacity.

### SUMMARY OF THE INVENTION

The technique disclosed in Patent Document 1, however, has the following disadvantage in recovering the capacity of lithium-ion batteries. That is, replenishing the battery with lithium ions as the result of judging that the decreased battery capacity is due to the decreased lithium ions sometimes accelerates the deterioration of lithium-ion batteries. In fact, there is an instance in which lithium ion-batteries working, at high temperatures are judged to have decreased in capacity due to decreased lithium ions despite a short lapse of time after replenishment. In such an instance, replenishment with lithium ions is likely to deteriorate the batteries.

A probable reason for what is mentioned above is that the replenished lithium, ions hardly spread throughout the anode. In other words, the supplied lithium ions densely remain near the point of supply and take time to diffuse through the anode. This phenomenon is depicted in FIG. 8. Replenishment with lithium ions in such a state causes metallic lithium to separate out (forming lithium dendrites) where lithium ions concentrate, thereby reducing the battery life.

The foregoing also applies to replenishing the cathode with lithium ions; difficulties are involved in evenly replenishing the cathode with lithium ions. In other words, the supplied lithium ions densely remain near the point of supply and take time to diffuse through the cathode. This phenomenon is depicted in FIG. 10. Replenishment with lithium ions in such a state brings about discharging where lithium ions concentrate. Repeating replenishment with lithium ions under this situation brings about overdischaring in the region of discharged state. This leads to a reduced battery life.

The present invention covers a lithium-ion battery system which includes: a lithium-ion battery having a cathode, an anode, an electrolyte, and a third electrode with an active material formed from a lithium-containing material; a connecting unit capable of establishing an electrically connected state or an electrically disconnected state between the cathode and the third electrode and/or between the anode and the third electrode; and a control unit to control the lithium-ion battery. The control unit works such that the electrically connected state is not established again until a prescribed condition is satisfied for the physical quantity corresponding to the degree of concentration of lithium ions on the cathode or anode after it has switched from the electrically connected state to the electrically disconnected state.

The lithium-ion battery system according to the present invention avoids separation of metallic lithium in the anode or over-discharging in the anode and also permits adequate replenishment with lithium ions.

### BRIEF DESCRIPTION OF THE DRAWINGS

FIG. 1 is a schematic diagram showing the constitution of the lithium-ion battery system according to the present invention.

FIG. 2 is a sectional view of the cathode.

FIG. 3 is a sectional view of the anode.

FIG. 4 is a sectional view of the third electrode.

FIG. 5 is a schematic diagram showing the arrangement of the cathode, the anode, and the third electrode in the lithium-ion battery.

FIG. 6 is a graphical representation of the relation between the standing period and the capacity of the lithium-ion battery.

FIG. 7 is a graphical representation of the relation between the number of times of charging and discharging and the capacity of the lithium-ion battery.

FIG. 8 is a conceptual diagram illustrating the heavy replenishment with lithium ions and the diffusion of lithium ions in the anode.

FIG. 9 is a flow chart illustrating the processing by the lithium-ion battery system.

FIG. 10 is a conceptual diagram illustrating the heavy replenishment with lithium-ions in the anode.

FIG. 11 is a schematic diagram illustrating the constitution of the lithium-ion battery system according to the present invention.

### DESCRIPTION OF THE PREFERRED EMBODIMENTS

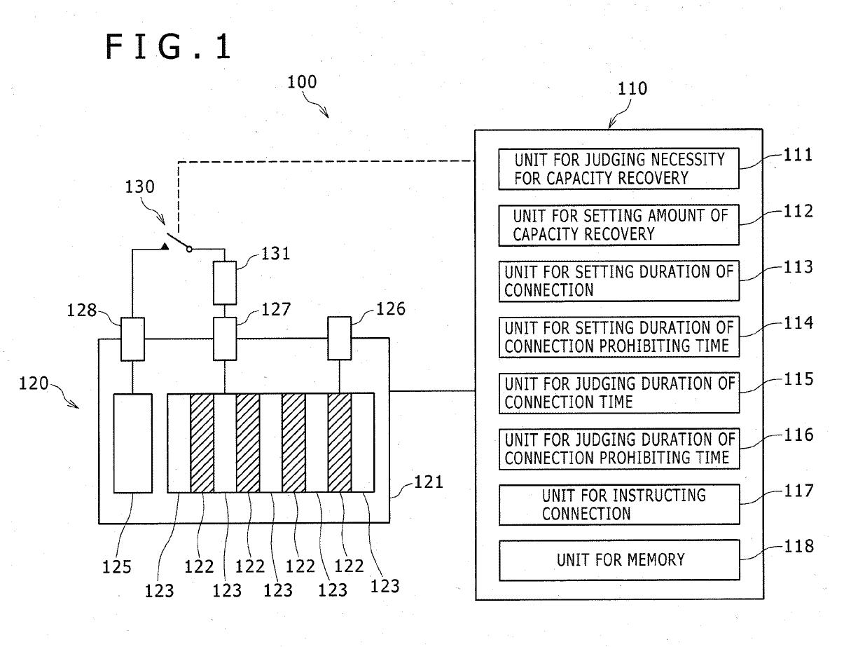

The lithium-ion battery system pertaining to the present invention is depicted in FIG. 1. The lithium-ion battery system 100 comprises the control unit 110, the lithium-ion battery 120, and the connecting unit 130. The lithium-ion battery 120, which is of laminate type, is constituted of a group of electrodes (each composed of the cathode 122, the anode 123, and the separator which are laminated one over another) and the third electrode 125, which are arranged in the battery container 121. The separator, which is not shown, is so placed as to separate the cathode 122, the anode 123, and the third electrode 125 from one another. In addition, each of the cathodes 122 and each of the anodes 123 are electrically connected together through current collectors (not shown). The battery container 121 is filled with an electrolyte and sealed to prevent the electrolyte from leakage.

The cathode 122, the anode 123, and the third electrode 125 respectively have the cathode terminal 126, the anode terminal 127, and the third electrode terminal 128 connected thereto. The connecting unit 130 establishes electrical connection and disconnection between the cathode terminal 126 and the third electrode terminal 128 or between the anode terminal 127 and the third electrode terminal 128. The connecting unit 130 is provided with an electromagnetic switch or the like. Moreover, the connecting unit 130 should preferably have the resistor 131 (0.01 to 10 kΩ) connected in series thereto so as to control current between the anode 123 and the third electrode 125. Incidentally, the lithium-ion battery system may also be constructed such that either the cathode 122 or the anode 123 is selectively replenished with lithium ions. In this case, the connecting unit 130 should be connected to the cathode terminal 126 and anode terminal 127 respectively through resistors with mutually different resistances. However, in the case where the lithium-ion battery system is constructed such that the potential difference between the cathode terminal 126 and the third electrode terminal 128 is equal to the potential difference between the anode terminal 127 and the third electrode terminal 128, it is only necessary to place the resistor 131 between the connecting unit 130 and the third electrode terminal 128; this structure helps reduce the number of parts.

The control unit 110 includes the unit for judging whether or not the capacity recovery is necessary 111, the unit for setting the amount of capacity recovery 112, the unit for setting the duration of connection 113, the unit for setting the duration of connection prohibiting time 114, the unit for judging the duration of connection time 115, the unit for judging the duration of connection prohibiting time 116, the unit for instructing connection 117, and the memory unit 118.

The unit 111 judges whether or not the lithium-ion battery 120 needs the capacity recovery. The unit 112 sets the amount of capacity recovery required by the lithium-ion battery 120, the unit 113 sets how long the connecting unit 130 should keep electrical connection according to the amount of capacity recovery which has been set by the unit 112, and the unit 114 sets the duration that lasts from the point at which the connecting unit 130 is switched from the electrically connected state to the electrically disconnected state to the point at which the connecting unit 130 is allowed to return to the electrically connected state.

The unit 115 judges whether or not the predetermined time has elapsed after the point at which the connecting unit 130 established the electrically connected state, the unit 116 judges whether or not the predetermined time has elapsed after the point at which the connecting unit 130 is switched from the electrically connected state to the electrically disconnected state, the unit 117 instructs the connecting unit 130 to switch to either the electrically connected state or the electrically disconnected state, and the unit 118 stores such values as the amount of capacity recovery, the duration of time, and the duration of prohibition of connection, and any other information required.

Incidentally, the foregoing is based on the assumption that the connecting unit 130 selects the electrical connection and disconnection between the anode terminal 126 and the third electrode terminal 128. However, the connecting unit 130 may be one which selects the electrical connection and disconnection between the cathode terminal 125 and the third electrode terminal 128.

### Lithium-Ion Battery

The following is a description of the lithium-ion battery 120, with an emphasis placed on the cathode 122, the anode 123, and the third electrode 125.

### Cathode

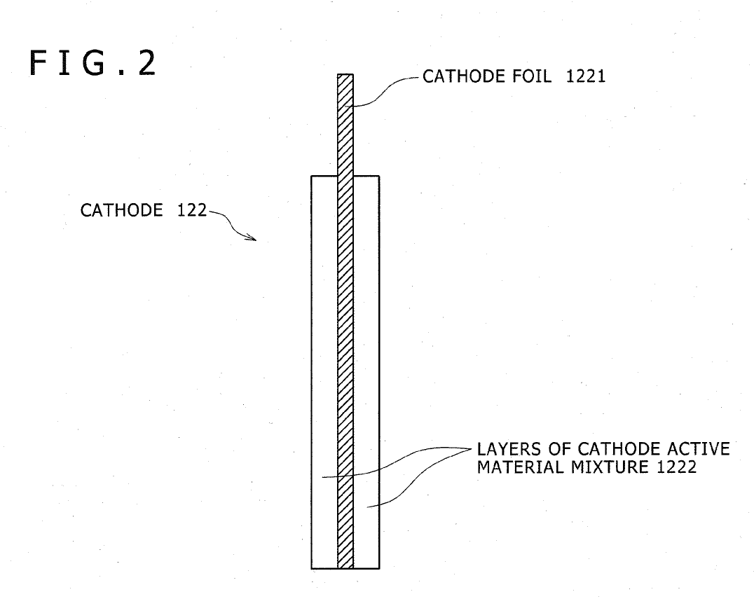

As shown in section in FIG. 2, the cathode 122 consists of the cathode foil 1221 and the layers of cathode active material mixture 1222, with the latter formed on both sides of the former. The layers of active material mixture 1222 are formed by coating both sides of the cathode foil 1221 with the cathode active material mixture 1222 in slurry form. This slurry is composed of 88 wt % of LiNi_{1/3}Co_{1/3}Mn_{1/3}O₂ (as the cathode active material), 5 wt % of acetylene black (as the conducting agent), and 7 wt. % of PVDF (polyvinylidene fluoride), which are mixed together in N-methyl-2-pyrrolidone. The slurry is applied onto the cathode foil 1221, which is an aluminum foil 25 μm thick, and then dried and pressed to give the layers of cathode active material mixture 1222. The coated aluminum foil is cut into a proper size for the cathode 122.

### Anode

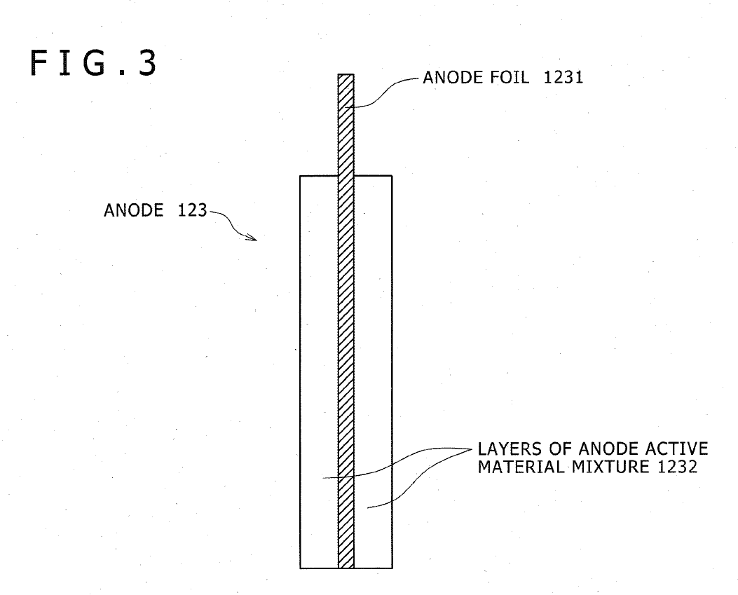

As shown in section in FIG. 3, the anode 123 consists of the anode foil 1231 and the layers of anode active material mixture 1232, with the latter formed on both sides of the former. The layers of anode material mixture 1232 are formed by coating both sides of the anode foil 1231 with the anode active material mixture 1232 in slurry form. This slurry is composed of 90 wt % of hardly graphitizable carbon (as the anode active material) and 10 wt % of PVDF (polyvinylidene fluoride), which are mixed together in N-methyl-2-pyrrolidone. The slurry is applied onto the anode foil 1231, which is a copper foil 10 μm thick, and then dried to give the layers of anode active material mixture 1232. The coated copper foil is cut into a proper size for the anode 123.

### Third Electrode

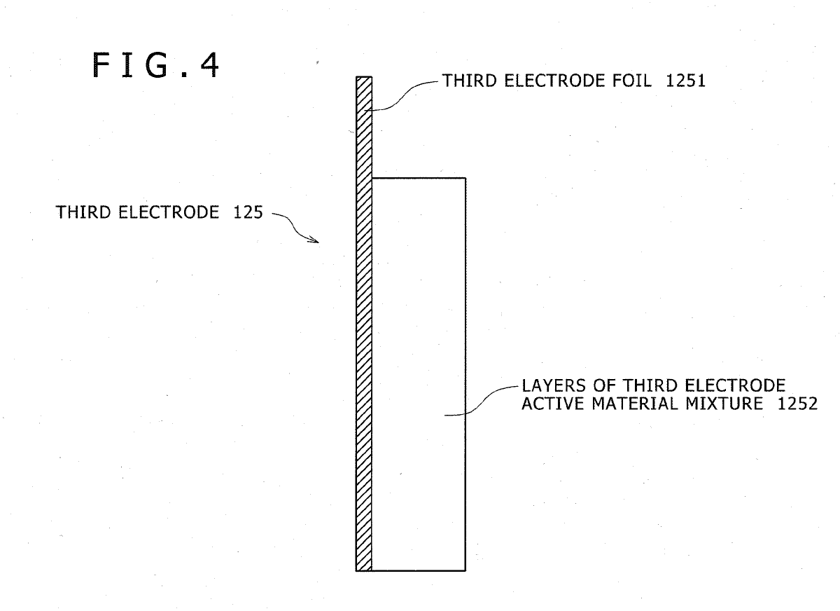

As shown in section in FIG. 4, the third electrode 125 consists of the third electrode foil 1251 and the layer of the third electrode active material mixture 1252, with the latter covering one side of the former. The layer 1252 is formed by coating one side of the third electrode foil 1251 with the third electrode active material mixture in slurry form. This slurry is composed of 88 wt % of LiNi_{1/3}Co_{1/3}Mn_{1/3}O₂ (as the third electrode active material), 5 wt % of acetylene black (as the conducting agent), and 7 wt % of PVDF (polyvinylidene fluoride), which are mixed together in N-methyl-2-pyrrolidone. The slurry is applied onto one side of the third electrode foil 1251, which is an aluminum foil 25 μm thick, and then dried and pressed to give the layer of the third electrode active material mixture 1252. The coated aluminum foil is cut into a proper size for the third electrode 125. Although the third electrode employs the same active material as used in the cathode 122 in the foregoing case, the active material for the third electrode may be replaced by any known one containing lithium, such as metallic lithium and lithium compound containing silicon or tin. Such an active material may be combined with a copper foil to form the third electrode 125 having a high capacity.

The layer of the third electrode active material mixture 1252 is thicker than the cathode mixture layer 1222 and the anode mixture layer 1232, so that the third electrode 125 contains more lithium per unit area than the cathode 122 and the anode 123. This permits more frequent replenishment with lithium ions. The material such as metallic lithium and lithium compound containing silicon or tin are preferably used for the third electrode 125, which also achieves more frequent replenishment of lithium ions without thickening the electrode.

### Fabrication of Lithium-Ion Battery

A multiplicity of the cathode 122 and a multiplicity of the anode 123 are placed alternately one over another, with a separator interposed between them, so as to fabricate a group of electrodes. The separator is a porous laminate sheet of polypropylene and polyethylene. The cathode 122, the anode 123, and the third electrode 125 are provided respectively with the cathode terminal 126, the anode terminal 127, and the third electrode terminal 128. The group of electrodes and the third electrode are placed in the battery container 121 in such a way that each of their terminals partly projects from the battery container 121. Subsequently, the battery container 121 is filled with an electrolyte and then sealed by fusion bonding. The electrolyte is a solution of lithium hexafluorophosphate (1 mol/L) dissolved in a mixture (1:1 by volume) of ethylene carbonate and diethyl carbonate. The battery container 121 is one which is formed from laminate film.

The third electrode 125 is located outside the group of electrodes or in the region near the battery container 121. Moreover, the third electrode 125 is arranged such that one side thereof on which is formed the layer of the third electrode active material 1252 faces the anode 123.

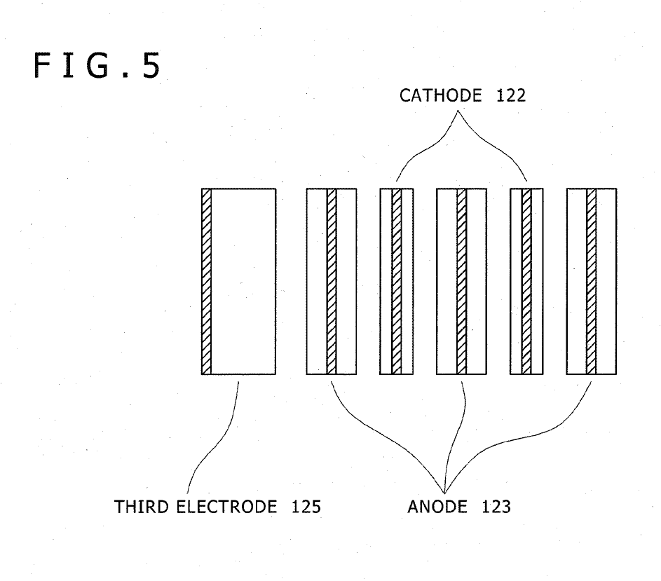

There is schematically shown in FIG. 5 a typical arrangement of the cathode 122, the anode 123, and the third electrode 125 in the lithium-ion battery. In the illustrated arrangement, the third electrode 125 faces the anode 123. The cathode 122 is composed of the cathode foil and the layers of cathode active material mixture, the anode 123 is composed of the anode foil and the layers of anode active material mixture, and the third electrode 125 is composed of the third electrode foil and the layers of third electrode active material mixture. Incidentally, the separator is not shown for the sake of brevity. The illustrated battery structure includes a plurality of both the cathode 122 and the anode 123. It is assumed that the third electrode 125 is constructed such that the layer of third electrode active material mixture 1252 is formed on one side of the third electrode foil 1251. However, the third electrode 125 may be constructed in such a way that the layer of third electrode active material mixture 1252 is formed on both sides of the third electrode foil 1251. Test for capacity recovery of lithium-ion battery (part 1)

The following is a description of the process for recovering the capacity of the lithium-ion battery.

### Charging and Discharging

There were fabricated five samples of the lithium-ion battery 120 mentioned above. Each of the lithium-ion batteries was charged at 25° C. through the cathode terminal 126 and the anode terminal 127 with a charging current of 200 mA (with the current and voltage kept constant) until the battery voltage increased to 4.1 V from starting voltage 2.7 V. Then, the battery was discharged with a discharging current of 200 mA (with the current kept constant) until the battery voltage decreased to 2.7 V from starting voltage 4.1 V. Charging and discharging in this manner constitute one cycle of charging and discharging. The battery underwent three cycles of charging and discharging. Subsequently, the battery was charged again with a charging current of 200 mA (with the current and voltage kept constant) until the battery voltage increased to 4.1 V from starting voltage 2.7 V and then the battery was discharged with a discharging current of 200 mA until the battery voltage decreased to 2.7 V from starting voltage 4.1 V (with the current kept constant). As the result of testing for discharge capacity, the lithium-ion batteries were found to have a discharge capacity of 209 mAh. This discharge capacity is regarded as the initial battery capacity of each of the five lithium-ion batteries 120.

### Accelerated Degradation

Each of the lithium-ion batteries mentioned above was charged at 25° C. with a charging current of 200 mA (with the current and voltage kept constant) until the battery voltage increased to 4.1 V from starting voltage 2.7 V. Then, the battery was allowed to stand at 50° C. for 10 days for accelerated degradation. The lithium-ion battery (which had undergone accelerated degradation) was discharged at 25° C. with a discharging current of 200 mA (with the current kept constant) until the battery voltage decreased to 2.7 V from starting voltage 4.1 V. As the result of testing for discharge capacity, all the lithium-ion batteries were found to have a discharge capacity of 186 mAh. This implies that the batteries tested decreased in capacity by 23 mAh from their initial capacity.

### Process for Capacity Recovery

In the next step, each of the lithium-ion batteries mentioned above was charged at 25° C. with a charging current of 200 mA (with the current and voltage kept constant) until the battery voltage increased to 4.1 V from starting voltage 2.7 V. Subsequently, the battery was discharged for 15 hours with a discharging current of 2 mA, with the anode connected to the third electrode, so that lithium ions corresponding to 30 mAh were transferred from the third electrode to the anode.

### Confirmation of Capacity

The five lithium-ion batteries which had undergone the process for capacity recovery as mentioned above were allowed to stand at 25° C. After the lapse of one day, one of the five lithium-ion batteries was discharged with a constant discharging current of 200 mA until the battery voltage decreased to 2.7 V from starting voltage 4.1 V. The battery was found to have a discharge capacity of 187 mAh. The remaining four lithium-ion batteries were continuously allowed to stand at 25° C.

After the lapse of three days, one of the four lithium-ion batteries was discharged with a constant discharging current of 200 mA until the battery voltage decreased to 2.7 V from starting voltage 4.1 V. The battery was found to have a discharge capacity of 197 mAh. The remaining three lithium-ion batteries were continuously allowed to stand at 25° C. Furthermore, after the lapse of five days, one of the three lithium-ion batteries was discharged with a constant discharging current of 200 mA until the battery voltage decreased to 2.7 V from starting voltage 4.1 V. The battery was found to have a discharge capacity of 201 mAh.

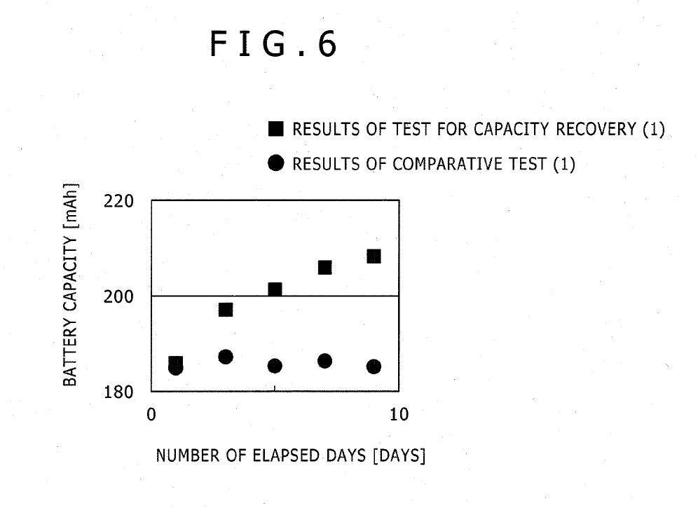

After the lapse of seven days and nine days, the discharge capacity was measured in the same way as mentioned above. The results were 206 mAh and 209 mAh, respectively, as shown in FIG. 6 (with solid squares ▪). Additional samples of the lithium-ion battery were produced and tested in the same way as above, and there were obtained similar results.

The foregoing results suggest the following. The lithium-ion battery which has undergone accelerated degradation does not recover its capacity immediately after the process for capacity recovery. However, it gradually recovers its capacity with the lapse of time for standing. The lithium-ion battery mentioned above recovered its capacity almost completely after standing for nine days. The duration required for capacity recovery varies depending on the size and structure of the lithium-ion battery. Actually, the duration required for the lithium-ion battery 120 to recover its original capacity after discharging may be set up by direct measurement of recovered capacity or by estimation.

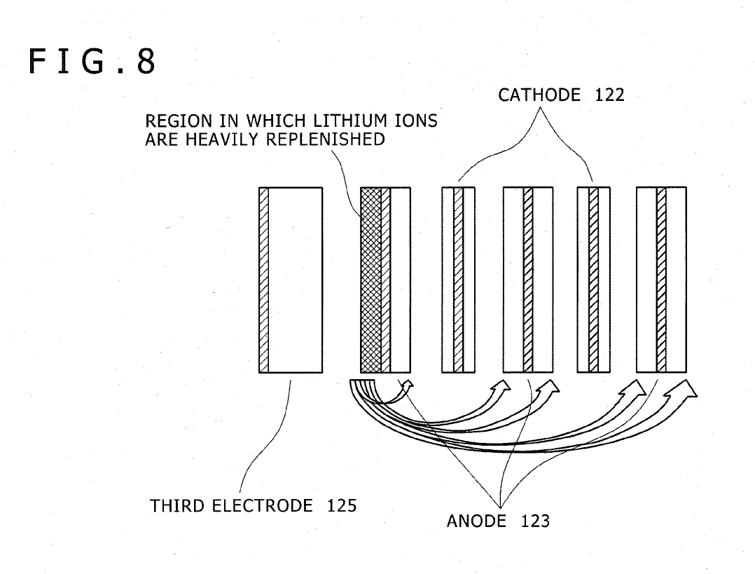

The fact that the lithium-ion battery recovers its capacity with the lapse of time after the process for capacity recovery may be reasoned as follows although no full elucidation has been made yet. As explained above with reference to FIG. 8, the lithium ions supplied from the third electrode to the anode concentrate on the anode close to the third electrode (which is the source of lithium ions) but do not spread throughout the anode immediately after supply. The lithium-ion battery in this state does not recover its capacity.

That part of the anode which has been heavily replenished with lithium ions has a relatively high concentration of lithium ions. On the other hand, that part of the anode through which lithium ions do not yet spread has a relatively low concentration of lithium ions. The difference in concentration of lithium ions on the anode surface manifests itself as the potential difference proportional to it. This potential difference is considered to cause the supplied lithium ions to spread all over the anode surface, thereby equating the concentration of lithium ions. Thus, the lithium ions supplied gradually spread all over the anode surface with the lapse of time. With lithium ions spreading, the lithium-ion battery gradually recovers its capacity, and with lithium ions fully spread, the lithium-ion battery recovers its capacity almost completely. How the lithium ions supplied spread all over the anode surface is pictorially shown with arrows in FIG. 8.

### Comparative Test (Part 1)

Lithium-ion batteries were examined for capacity by the same procedure as mentioned above in “Test for capacity recovery of lithium-ion battery (part 1)” except that the process for capacity recovery was omitted. The results in FIG. 6 (with solid circles •) show that the lithium-ion batteries which have undergone only accelerated degradation fail to recover their capacity that has been lowered. Test for capacity recovery of lithium-ion battery (part 2) Charging and discharging

The lithium-ion battery 120 fabricated as mentioned above was examined for the initial battery capacity in the same way as in the capacity recovery test (part 1) mentioned above. That is, the lithium-ion battery was charged at 25° C. through the cathode terminal 126 and the anode terminal 127 with a charging current of 200 mA (with the current and voltage kept constant) until the battery voltage increased to 4.1 V from starting voltage 2.7 V. Then, the battery was discharged with a discharging current of 200 mA (with the current kept constant) until the battery voltage decreased to 2.7 V from starting voltage 4.1 V. Charging and discharging in this manner constitute one cycle of charging and discharging. The battery underwent three cycles of charging and discharging. Subsequently, the battery was charged again with a charging current of 200 mA (with the current and voltage kept constant) until the battery voltage increased to 4.1 V from starting voltage 2.7 V and then the battery was discharged with a discharging current of 200 mA until the battery voltage decreased to 2.7 V from starting voltage 4.1 V (with the current kept constant). The lithium-ion battery was found to have a discharge capacity of 210 mAh. This discharge capacity is regarded as the initial battery capacity of the lithium-ion batteries 120.

### Accelerated Degradation

The lithium-ion battery 120 mentioned above underwent accelerated degradation test in the same way as in “Test for capacity recovery (part 1)” mentioned above. That is, the lithium-ion battery was charged at 25° C. with a charging current of 200 mA (with the current and voltage kept constant) until the battery voltage increased to 4.1 V from starting voltage 2.7 V. Then, the battery was allowed to stand at 50° C. for 10 days for accelerated degradation. The lithium-ion battery (which had undergone accelerated degradation) was discharged at 25° C. with a discharging current of 200 mA (with the current kept constant) until the battery voltage decreased to 2.7 V from starting voltage 4.1 V. The lithium-ion battery was found to have a discharge capacity of 188 mAh. This implies that the battery tested decreased in capacity by 22 mAh from its initial capacity.

### Process for Capacity Recovery

In the next step, the lithium-ion battery mentioned above was charged at 25° C. with a charging current of 200 mA (with the current and voltage kept constant) until the battery voltage increased to 4.1 V from starting voltage 2.7 V. Subsequently, the battery was discharged for 15 hours with a discharging current of 2 mA, with the anode connected to the third electrode, so that lithium ions corresponding to 30 mAh were transferred from the third electrode to the anode.

### Confirmation of Capacity

The lithium-ion battery which had undergone the process for capacity recovery as mentioned above was discharged (a second time after accelerated degradation) with a constant discharging current of 200 mA until the battery voltage decreased to 2.7 V from starting voltage 4.1 V. The lithium-ion battery was found to have a discharge capacity of 188 mAh. This implies that the lithium-ion battery did not change in discharge capacity immediately after accelerated degradation.

Next, the lithium-ion battery was charged at 25° C. with a charging current of 200 mA (with the current and voltage kept constant) until the battery voltage increased to 4.1 V from starting voltage 2.7 V. Then, the lithium-ion battery was discharged (a second time after accelerated degradation) with a constant discharging current of 200 mA until the battery voltage decreased to 2.7 V from starting voltage 4.1 V. The discharge capacity was found to be 199 mAh. This implies that the lithium-ion battery restored 11 mAh from the discharge capacity measured immediately after accelerated degradation. Subsequently, the lithium-ion battery was charged with a charging current of 200 mA (with the current and voltage kept constant) until the battery voltage increased to 4.1 V from starting voltage 2.7 V. Then, the lithium-ion battery was discharged (a third time after accelerated degradation) with a constant discharging current of 200 mA until the battery voltage decreased to 2.7 V from starting voltage 4.1 V. The discharge capacity was found to be 202 mAh. This implies that the lithium-ion battery restored 14 mAh from the discharge capacity measured immediately after accelerated degradation.

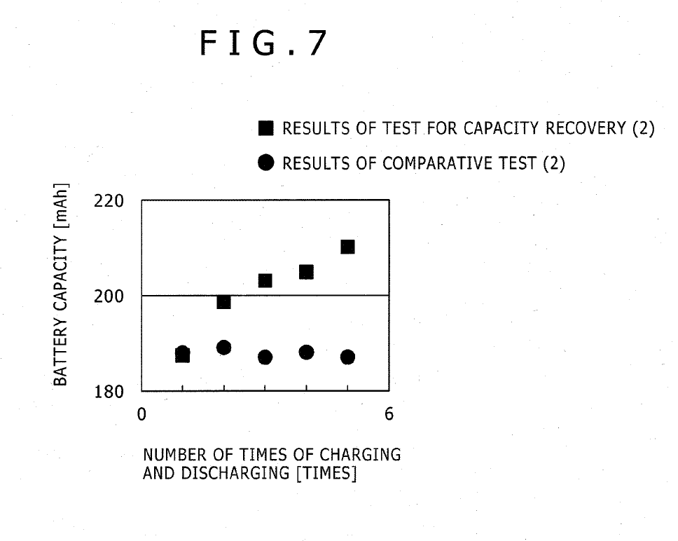

The same procedure as mentioned above was repeated to measure the discharge capacity after the fourth and fifth discharging that follow accelerated degradation. The discharge capacity was found to be 205 mAh and 210 mAh, respectively. This implies that the battery capacity was restored to that measured before accelerated degradation owing to the fifth discharging which was performed after accelerated degradation. This result is shown in FIG. 7 (with solid squares ▪. Additional samples of the lithium-ion battery were produced and tested in the same way as above, and there were obtained similar results.

The foregoing results suggest the following. The lithium-ion battery 120 which has undergone accelerated degradation does not recover its capacity immediately after the process for capacity recovery. However, it gradually recovers its capacity owing to repeated charging and discharging. The lithium-ion battery tested herein nearly restored its original capacity after five repetitions of charging and discharging. The number of times for repeated charging and discharging required for capacity recovery varies depending on the size and structure of the battery and the material of the anode. The number of times for repeated charging and discharging required for the lithium-ion battery 120 to nearly restore its original capacity after its decrease in capacity may be determined by actual measurements of capacity recovery or by curve fitting from actually measured values of recovery.

The fact that the lithium-ion battery recovers its capacity after repeated charging and discharging may be reasoned as follows although no full elucidation has been made yet. As explained above in “Test for capacity recovery (part 1)”, lithium ions supplied from the third electrode to the anode concentrate on the anode close to the third electrode and such lithium ions migrate across the cathodes and anodes for their uniform distribution as the result of charging and discharging.

### Comparative Test (Part 2)

Lithium-ion batteries were examined for capacity by the same procedure as mentioned above in “Test for capacity recovery of lithium-ion battery (part 2)” except that the process for capacity recovery was omitted. The results in FIG. 7 (with solid circles •) show that the lithium-ion batteries which have undergone only accelerated degradation fail to recover their capacity that has been lowered.

The results mentioned above suggest that the degree of concentration of lithium ions supplied from the third electrode to the cathode or anode plays an important role in constituting any system for the lithium-ion battery to adequately recover its capacity. The degree of concentration may be termed as the degree of uneven distribution or the degree of localization. The concentration of lithium ions actually occurs inside the lithium-ion battery, and hence it cannot be measured directly while the lithium-ion battery is in use. One way to circumvent this problem is to measure a physical quantity corresponding to the degree of concentration of lithium ions on the cathode or anode after switching from the electrically connected state to the electrically disconnected state, and then prevent the electrically connected state from recurring until prescribed conditions are satisfied. This helps provide the lithium-ion battery system capable of adequate replenishment with lithium ions without deposition of metallic lithium on the anode or over-discharging in the cathode.

One example of the physical quantity corresponding to the degree of concentration of lithium ions is the elapsed time after switching from the electrically connected state to the electrically disconnected state. The prescribed condition in this case is that the elapsed time is longer than the prescribed length of time. The physical quantity may also be the amount of increased capacity of the lithium-ion battery which is determined after switching from the electrically connected stat to the electrically disconnected state. The prescribed condition in this case is that the amount of increased capacity is larger than a prescribed amount. Furthermore, the physical quantity may also be the number of repeated charging and discharging which is counted after switching from the electrically connected state to the electrically disconnected state. The prescribed condition in this case is that the number of repeated charging and discharging is larger than the prescribed number of times.

### Lithium-Ion Battery System

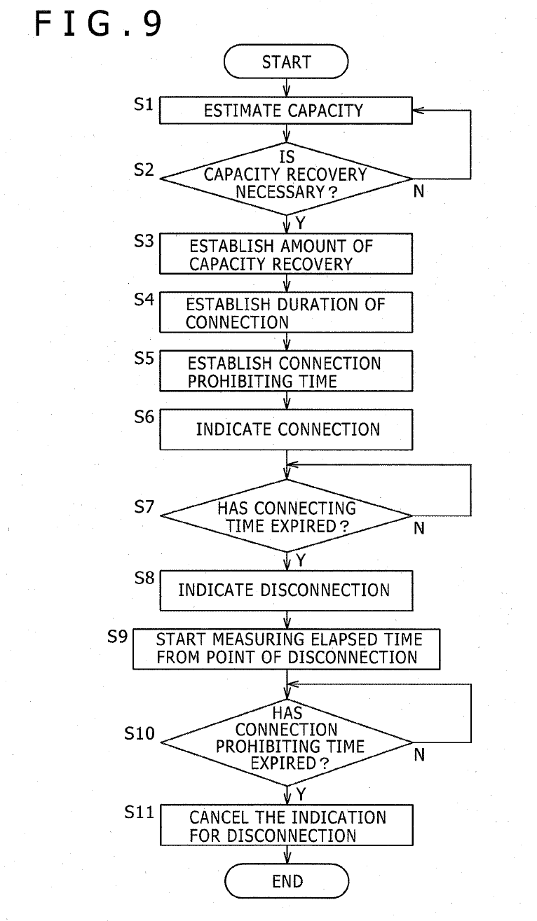

The following is a description of the capacity recovery for the lithium-ion battery 120 employed in the lithium-ion battery system 100, in which processing is performed by the control unit 110 according to the flow chart shown in FIG. 9.

The process shown in FIG. 9 starts with Step S1 to estimate the capacity of the lithium-ion battery 120. In response the estimated capacity, Step S2 judges whether or not the lithium-ion battery 120 needs capacity recovery. If Step S2 judges that the capacity recovery is necessary, the process proceeds to Step S3; otherwise, the process returns to Step Si.

Step S3 establishes the amount of capacity recovery and then proceeds to Step S4. In response to the amount of capacity recovery established by Step S3, Step S4 establishes the duration for the connecting unit 130 to remain in the electrically connected state, and then Step S4 proceeds to Step S5. The duration of connection is calculated by dividing the potential difference among the cathode 122, the anode 123, and the third electrode 125 by the resistance between the electrodes, thereby giving the current value, and then dividing the intended amount of capacity recovery by the thus obtained current value. Step S5 establishes the connection prohibiting time (the duration in which the connecting unit 130 switches from the electrically connected state to the electrically disconnected sate but is not allowed to return to the electrically connected state again). Then, Step S5 proceeds to Step S6.

Step S6 indicates to the connecting unit 130 to establish the electrically connected state and then proceeds to Step S7. Step S7 judges whether or not the connecting time specified by Step S4 has expired and then proceeds to Step S8 in case of affirmative judgment. However, in case of negative judgment, Step S7 repeats itself. Step S8 indicates to the connecting unit 130 to establish the electrically disconnected state and then proceeds to Step S9.

Step S9 starts measuring the elapsed time from the point at which the connecting unit 130 switched from the electrically connected state to the electrically disconnected state, and then it proceeds to Step S10. In other words, Step S9 finishes the step of capacity recovery (for the lithium-ion battery 120) to be performed for the first time and simultaneously starts the step for capacity recovery to be performed for the second time. Step S10 judges whether or not the connection prohibiting time specified by Step S5 has expired and then proceeds to Step S11 in case of affirmative judgment. However, in case of negative judgment, Step S10 repeats itself. Step S11 cancels the indication for disconnection and makes it ready to start the step for capacity recovery for the second time. Thus, the process for capacity recovery is completed.

The procedure of. Step S1 to estimate the capacity of the lithium-ion battery 120 may be accomplished by any known method, such as measurement of battery's impedance or other attributes (from which capacity is calculated) and direct measurement of battery's capacity.

Step S2 judges whether or not the battery needs capacity recovery when the battery's capacity decreases below the initially established lower limit. Step S3 establishes the amount of capacity recovery in such a way that the battery recovers its capacity when its capacity decreases below a predetermined lower limit. For example, the lower limit may be 80% of the initial capacity and the amount of capacity recovery may be 5%. The lower limit should preferably be 80% to 90% and the amount of capacity recovery should preferably be less than 5%, because it is desirable that the battery capacity remains constant for a long period of time rather than it changes steeply in a short time. Moreover, the fluctuation of battery capacity should be within 3%.

For example, it may be possible to assume that the lithium-ion battery 120 needs capacity recovery when its capacity decreases below 85% of its initial capacity and the amount of capacity recovery (to be established in Step S3) is 3% of its initial capacity. In this case, the lithium-ion battery retains 85% to 88% of its initial capacity after its capacity has decreased below 85% of its initial capacity.

The connecting time to be established in Step S4 and the connection prohibiting time to be established in Step S5 vary depending on the size and structure of the lithium-ion battery 120 and the material of the anode. The connection prohibiting time may be established from a predetermined value or by calculating the time required for the amount of capacity recovery to exceed a predetermined value, the calculation based on the amount of capacity recovery obtained by direct measurement or assumption of the battery's capacity. Such data as the battery's capacity before recovery, the established amount of capacity recovery, the connection time, and the connection prohibiting time are stored in the memory unit 118.

### Modified Example 1

Judgment about the need for capacity recovery may be made according to the standard which vary between the first judgment and the second and succeeding judgments. The amount of capacity recovery may also vary between the first judgment and the second and succeeding judgments. For example, the first judgment about the need for capacity recovery may be made when the capacity of the lithium-ion battery 120 decreases to 80% of the initial capacity, and the amount of capacity recovery is set at 7% of the initial capacity. And, the second and succeeding judgments about the need for capacity recovery may be made when the capacity of the lithium-ion battery 120 decreases to 84% of the initial capacity, and the amount of capacity recovery is set at 3% of the initial capacity.

The foregoing setting produces the following effect. The first judgment about the need for capacity recovery for the lithium-ion battery 120 (fresh one) is made after the battery has been used as long a period as possible, with the amount of capacity recovery set comparatively large. The second and succeeding judgments about the need for capacity recovery are made, with the amount of capacity recovery set small, such that the battery works while keeping its capacity within a comparatively small range of 84 to 87% of the initial capacity.

### Modified Example 2

According to the procedure mentioned above, Step S5 establishes the connection prohibiting time. This step allows the capacity recovery to take place again only after the lithium-ion battery 120 has undergone capacity recovery and a prescribed length of time has elapsed. However, the setting of the connection prohibiting time is not the only condition for capacity recovery to be performed again. For example, the condition may be the number of charging and discharging performed after capacity recovery. In this case, Step S9 counts the number of charging and discharging which have been performed after the point at which the connecting unit 130 has switched from the electrically connected state to the electrically disconnected state. And, Step S7 proceeds to Step S8 according to whether or not the number of charging and discharging has reached the prescribed number, and Step S8 judges whether or not it indicates to the connecting unit 130 to make connection. Another possible way is to measure the amount of capacity recovery after the capacity recovery processing and also measure the elapsed time and/or the number of charging and discharging after the capacity recovery processing. The thus measured amount of capacity recovery may be used as the index for the first capacity recovery processing. The index for the second and succeeding capacity recovery processing may be the elapsed time and/or the number of charging and discharging required for the amount of capacity recovery which has been found in the first processing. The connection prohibiting time may vary depending on the materials used. For example, it should preferably be longer for graphite as the anode active material, because graphite contributes to flat potential and takes a long time for the gradient of lithium ion concentration to become uniform.

### Modified Example 3

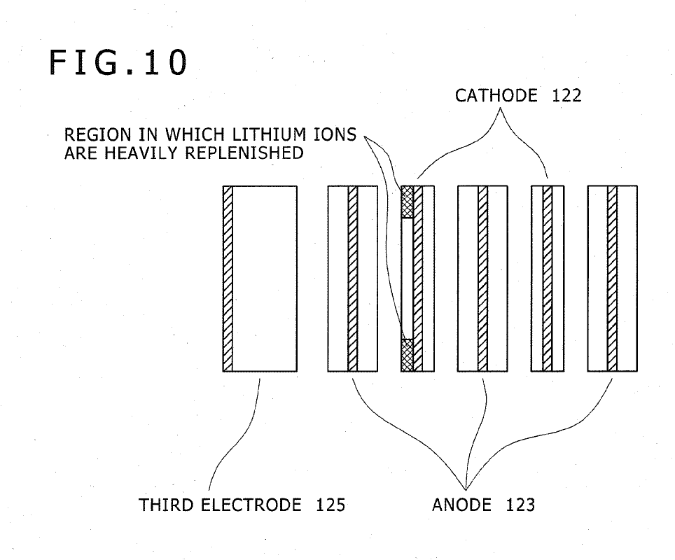

It is assumed in the foregoing that the connecting unit 130 connects the anode terminal 127 to the third electrode terminal 128, thereby permitting a specific current flow between the anode 123 and the third electrode 125, and hence causing lithium ions to migrate from the third electrode 125 to the anode 123. However, this wiring may be modified such that the connecting unit 130 connects the cathode terminal 126 to the third electrode terminal 128, thereby permitting a specific current flow between the cathode 122 and the third electrode 125, and hence causing lithium ions to migrate from the third electrode 125 to the cathode 122. In this case, lithium ions supplied from the third electrode 125 to the cathode 122 concentrate on the cathode near the third electrode immediately after supply. This is illustrated in FIG. 10.

### Modified Example 4

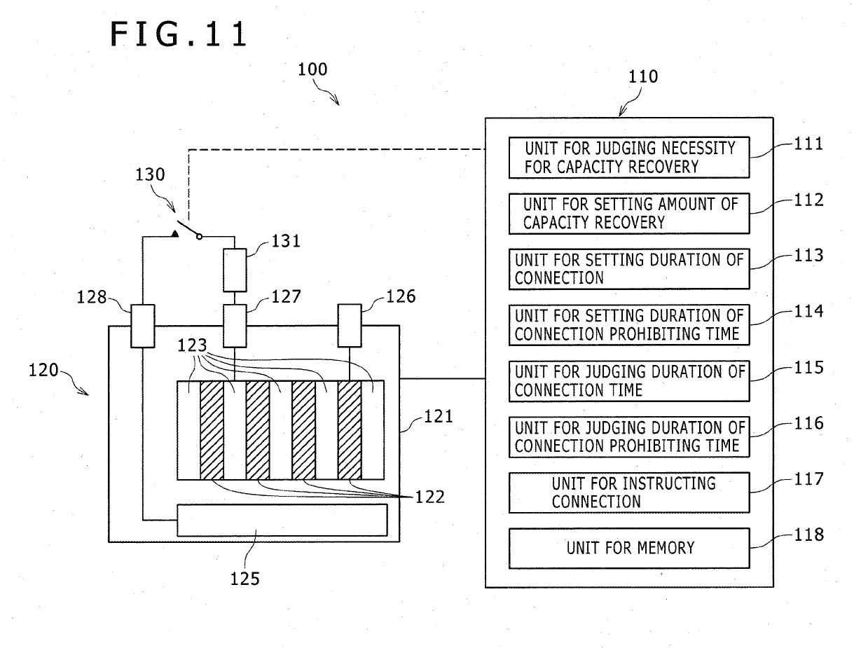

It is assumed in the foregoing that the lithium-ion battery is of laminate type having a group of electrodes (each composed of the cathode 122, the anode 123, and the separator) which are laminated one over another. However, the lithium-ion battery may also be of wound type (having the cathode, anode, and separator wound in layers) or any other type. In addition, the third electrode 125 may be positioned as shown in FIG. 11 instead of being positioned next to the outermost anode of the electrode group as shown FIG. 1.

### Modified Example 5

Although the control unit 110 internally functions as mentioned above, it may also inform the user about the instruction for connection (or about the fact that the instruction for connection has been issued) by means of a display (not shown) or a blinking lamp. Upon receipt of such information, the user may manually perform the process for capacity recovery.

1. A lithium-ion battery system comprising:
a lithium-ion battery having a cathode, an anode, an electrolyte, and a third electrode with an active material formed from a lithium-containing material;
a connecting unit capable of establishing an electrically connected state or an electrically disconnected state between the cathode and the third electrode and/or between the anode and the third electrode; and
a control unit to control the lithium-ion battery, wherein
the control unit controls the control unit which has switched from the electrically connected state to the electrically disconnected state such that the electrically connected state is not established again until a prescribed condition is satisfied for the physical quantity corresponding to the degree of concentration of lithium ions on the cathode or anode.

2. The lithium-ion battery system as defined in claim 1, wherein the control unit permits a specific current flow between the cathode and the third electrode or between the anode and the third electrode, thereby achieving migration of lithium ions to the cathode or anode, when the connecting unit is in the electrically connected state.

3. The lithium-ion battery system as defined in claim 1, wherein the prescribed condition is that the elapsed time from the point at which the electrically connected state is switched to the electrically disconnected state is longer than a prescribed length of time.

4. The lithium-ion battery system as defined in claim 1, wherein the prescribed condition is that the capacity of the lithium-ion battery increases more than a prescribed one after a lapse of time from the point at which the electrically connected state is switched to the electrically disconnected state.

5. The lithium-ion battery system as defined in claim 1, wherein the control unit performs control in such a way that the connecting unit takes on the electrically connected state on the basis of the capacity of the lithium-ion battery.

6. The lithium-ion battery system as defined in claim 1, wherein the third electrode contains lithium in an amount per unit area which is larger than the amount of lithium per unit area in at least either of the cathode or anode.

7. The lithium-ion battery system as defined in claim 2, wherein the prescribed condition is that the elapsed time from the point at which the electrically connected state is switched to the electrically disconnected state is longer than a prescribed length of time.

8. The lithium-ion battery system as defined in claim 2, wherein the prescribed condition is that the capacity of the lithium-ion battery increases more than a prescribed one after a lapse of time from the point at which the electrically connected state is switched to the electrically disconnected state.

9. The lithium-ion battery system as defined in claim 2, wherein the control unit performs control in such a way that the connecting unit takes on the electrically connected state on the basis of the capacity of the lithium-ion battery.

10. The lithium-ion battery system as defined in claim 3, wherein the control unit performs control in such a way that the connecting unit takes on the electrically connected state on the basis of the capacity of the lithium-ion battery.

11. The lithium-ion battery system as defined in claim 4, wherein the control unit performs control in such a way that the connecting unit takes on the electrically connected state on the basis of the capacity of the lithium-ion battery.

12. The lithium-ion battery system as defined in claim 2, wherein the third electrode contains lithium in an amount per unit area which is larger than the amount of lithium per unit area in at least either of the cathode or anode.

13. The lithium-ion battery system as defined in claim 3, wherein the third electrode contains lithium in an amount per unit area which is larger than the amount of lithium per unit area in at least either of the cathode or anode.

14. The lithium-ion battery system as defined in claim 4, wherein the third electrode contains lithium in an amount per unit area which is larger than the amount of lithium per unit area in at least either of the cathode or anode.

15. The lithium-ion battery system as defined in claim 5, wherein the third electrode contains lithium in an amount per unit area which is larger than the amount of lithium per unit area in at least either of the cathode or anode.
